(19) United States
(12) Patent Application Publication
(10) Pub. No.: US 2007/0175350 A1
(43) Pub. Date: Aug. 2, 2007

(54) Fluted intermediate assembly formed in situ and having high resolution image that is used in consumer goods packaging

(76) Inventor: Jesse D. Crum, Fort Scott, KS (US)

Correspondence Address: WARD/KRAFT, INC., 2401 COOPER STREET, P. O. BOX 938, FT. SCOTT, KS, 66701, US

(21) Appl. No.: 11/341,121

(22) Filed: Jan. 27, 2006

(51) Int. Cl. B41F 33/00

(52) U.S. Cl. 101/483

(57) ABSTRACT

The present invention relates to an intermediate assembly that may be produced in situ and which finds uses in packaging applications. The assembly is formed from three substantially similar sheets of material, two of which may be printed with indicia that may include matching characteristics and the third sheet which is fluted to form a core on to which the two printed sheets are attached. The sheets are preferably pre-printed with high resolution graphics and or textual information prior to being formed into a laminated configuration that can be utilized in corrugated packaging type situations. The intermediate assembly is used in the formation of cartons, packages and the like that are intended to be used in various consumer applications such as parcel delivery, including the shipping and delivery of consumer packaged goods.

### CROSS-REFERENCES TO RELATED APPLICATIONS

None.

### FIELD OF THE INVENTION

The present invention relates to an intermediate assembly that may be produced in situ and which finds uses in packaging applications. The assembly includes a fluted core that has one or more base sheets that are preferably pre-printed with high resolution graphics and or textual information prior to being formed into a laminated configuration that can be utilized in corrugated packaging type situations. The intermediate assembly is used in the formation of cartons, packages and the like that are intended to be used in various consumer applications such as parcel delivery, including the shipping and delivery of consumer packaged goods.

The intermediate assembly of the present invention is formed from three substantially similar sheets of material, two of which may be printed with indicia that may include matching characteristics and the third sheet which is fluted to form a core on to which the two printed sheets are attached. In constructing a product in this configuration, the package or carton forms an enhanced communication vehicle that can be further used in explaining a product offering and thereby taking further advantage of a marketing campaign or theme.

### BACKGROUND OF THE INVENTION

There are currently a plethora of business communication constructions, marketing and advertising pieces and other items that are available in the market today for communicating products and services with an intended audience. Yet with this inordinately large selection of offerings and permutations, there remains a continuing need to develop new products due to changes in technology, societal trends, diversification of marketing, packaging and advertising campaigns and new information handling needs of businesses and consumers alike.

However, while printed products, such as pieces and other assemblies that are intended to be used in business communications, can be delivered in a wide variety of formats, constructions and configurations, the manufacturing of such diversified products may simply be unattainable by most producers of such products, particularly smaller sized manufacturers, or may simply be too expensive to justify expenditures for equipment that may be able to create such products.

Typically, one of the most significant limiting factors for a manufacturer in being able to produce a particular construction or expand product capabilities is the available equipment the manufacturer has on hand or which may be available on the market to generate such printed pieces. Such forms handling machinery and other printing apparatus even if available for acquisition can be quite expensive and in addition the equipment may require some customization before the equipment can be integrated into a particular manufacturing processes. Thus, egress into new product categories may simply not be possible due to cost constraints.

Equipment may be further limited by the type of stocks or substrates that can be effectively handled or processed by such presses thereby further limiting the potential output of the types of products from manufacturers. For example, board or tag stocks are exemplary materials that due to the thickness of the substrate cannot be handled by most types of equipment and thus cannot printed upon by such conventional printing technologies as flexographic.

Flexography is one exemplary conventional technology that is commonly used today for the printing of decorative items, packaging films and the like because of the ability of the technology to print substrates in multiple colors. However, flexography is one exemplary technology that suffers from the foregoing drawbacks, of being able to handle thicker substrates and add significant variability to the materials being produced.

Flexographic technology is commonly used today in the rendering of film packaging, marketing communications and normally will utilize a series of plates and one or more stations, containing inks; to apply colored images to the web as the web traverses the press. Through improvements in ink qualities and other modifications and enhancements in the technology, the image quality in flexographic presses and resulting products has improved to about 150 lines per inch. In addition, flexographic printing presses are also limited by the thickness of the substrates that can be effectively handled and processed by the equipment.

Typically, for a point of reference, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

While use of such conventional technology such as flexography is desirable in the printing of films and other materials due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy”. Other images such as those that use flesh tones or deep or rich colors, may look faded or “washed out”. The effects of this level of image resolution can detract from the product appearance which may diminish the value of the technology and the products produced. With increasing sophistication of consumers, as well as technology and expectations from each, such effects may be undesirable to potential end users.

The market for printed communication material is also changing and becoming more sophisticated. Such conventional business forms manufacturers have normally produced product runs that range in the hundreds of thousands to millions or even tens of millions of pieces for a single order. These single orders may be produced for example in connection with a multiple part medical form product, insurance form or the like. As such, the equipment that is used to produce product at these levels or quantities is then set up to handle only large manufacturing runs. The apparatus used in this type of fulfillment will normally only operate efficiently in this higher range of production quantities and often cannot be reconfigured as the apparatus has been constructed in such a specific manner so as to be able to optimize production efficiencies of these larger runs. Thus, even if a manufacturer wished to pursue smaller runs, particular niche markets opportunities, specialty configurations or orders sizes, the manufacturer is faced with the dilemma of making new capital expenditures to purchase equipment that specializes in this type of application. This along with the possibility of having to retrain existing personnel or hire and train new employees to generate this type of production activity places additional constraints on the decision making process.

Traditional manufacturers of business communications, such as business forms and labels, may also be limited in the type of jobs that a manufacturer will accept and have typically not pursued more lucrative areas such as consumer goods packaging due to the uniqueness of the equipment that may be used in producing such products. These additional factors may include the size of the job, or more particularly the order quantity or value of the order. That is, due to cost factors, a customer will not place an order with a manufacturer for a small to medium quantity of specialty pieces as the set up or make ready of the job makes the order cost prohibitive, even assuming that the manufacturer would accept the order if a particular price could be obtained to justify production.

A still further drawback of trying to migrate to smaller customer applications relates to quality of the pieces that need to be generated. With the focus of the market slowly shifting to smaller runs, the end user is now demanding a greater image quality than that typically associated with conventionally printed products. It is believed that one of the reasons for such far reaching changes is that budgets for marketing and business communications have been cut back in recent years and as such, end users want more from each piece that is produced rather than relying on the quantity of pieces to generate the desired result. In addition, marketers want to make a greater impact at every turn in the retail chain to try and maximize the chances for purchases of a particular product being offered. Providing opportunities to extend or enhance marketing trends has been commonly welcomed by such firms and such priorities or demands often drive manufacturers to seek out other opportunities.

With the change in focus to quality as opposed to quantity there are a number of products that to date are still out of reach of conventional manufacturers in that certain materials are simply to thick or unwieldy to be able to be handled by printing equipment and forms processing apparatus.

In addition, with the rise of consumer oriented services, such as increases in purchasing occurring over a global communications network; many products that are intended for retail or consumer use only reach the consumer in the original, relatively plain shipping package or container. These relatively bland packages which are stored in warehouses are placed on pallets on the floor and then the distribution company loads the package for delivery to the consumer. The customer then removes the goods from the package upon arrival at one's home. Thus, such conventional packaging does little in the way of marketing or encouraging point of sale type activity to entice a consumer to purchase one product over another or to acquire additional complimentary products, upgrades or other services that may be of interest to the consumer.

In this age of brand marketing, and positioning of products in the consumer focus, so much of the effort associated with advertising and marketing to the consumer through conventional media outlets (e.g. television, radio, magazines, etc.) is then lost, as the package does not necessarily complete the image or finish the delivery of the message that the manufacturer of the consumer good wishes to convey to prospective customers.

This situation of plain or bland packaging is further exacerbated in connection with large marketing or promotional initiatives such as may occur around particular holiday seasons, or with the release of long awaited software or hardware, publications or new product launches. Marketing and/or advertising agencies spend significant sums in order to communicate to the public the launch or release of a product or service. The effect of this large effort can be mitigated due to the relatively uneventful packaging in which the product is delivered to the ultimate consumer.

There have some attempts to modify packaging so as to make the packaging more appealing to consumers. Some cartons may have printed sheets, sheets that provide a picture of the product, that are applied directly to the exterior of the carton. Such sheets do not typically cover the face of the side of the carton to which the sheet has been applied and may in fact detract from the quality of the product. In addition, it often appears as if the sheet was applied post packaging, which is in fact typically the situation. In such instances, the sheets can appear splayed or crooked on the surface, may bubble up due to incomplete lamination or sloppy application of the sheet to the carton, may rip or tear upon handling during shipping or simply be removed from the exterior of the carton thereby defeating the purpose of applying the sheet. As such, a more effective and aesthetically appealing point of sale vehicle is needed for such indirect customer driven applications.

Paperboard has been previously printed, such as with what may be found in connection with consumer food packages. However, it is well known that paperboard packaging simply does not work in connection with delivery or courier situations as the paperboard material simply does not provide enough protection or durability during shipping when compared with materials such as corrugated stock and the like.

Thus, what is needed is a corrugated packaging type construction that can be produced in a novel manner that enables the utilization of high resolution imaging equipment. This would provide conventional manufacturers of business communication products with the ability to produce attractive and effective business communication laminates that may be used in preparing relatively thick stocks of material, such as corrugated packaging materials with high quality graphics thereby creating enhanced marketing platforms.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been found that there is no readily available method or process by which to create a high quality printed communication platform, substantially in situ, which can be used in conventional corrugated packaging applications. It has been found that by handling the components of a packaging laminate individually, the high quality graphics, matching and personalized indicia can be applied to the packaging carriers in order to provide a vehicle by which a marketing message can be carried completely to the end user customer.

In one exemplary embodiment of the presently described invention a method for producing a printed intermediate assembly for use in consumer goods packaging, is presented and includes the steps of initially providing a printable substrate which has first and second faces, first and second transversely extending edges and first and second longitudinally extending sides. The first face is then printed with high resolution graphics such as graphics that preferably have a resolution exceeding about 150 lines per inch and more preferably exceeding about 200 lines per inch.

Next, a core material is supplied, the core has a series of regularly occurring undulating portions and has first and second sides. The core of material will preferably be selected from a similar stock as the first printable substrate. Then, the first side of the core is affixed to the second face of the substrate such that the core is disposed substantially between the first and second transversely extending edges and first and second longitudinally extending sides of the first printable substrate.

A base sheet is adhered to the second side of the core. The base sheet will preferably be selected from a similar stock of material as the first printable substrate and the material that forms the core of the intermediate assembly. The base sheet has first and second faces, first and second transversely extending edges and first and second longitudinally extending sides. The base sheet is secured to the core opposite the substrate such that the core is disposed between the base sheet and the core to create a printed intermediate assembly having a fluted core.

In a still further exemplary embodiment of the presently described invention a printed intermediate blank for use in consumer goods packaging is produced in accordance with the following process that includes the steps of initially providing a printable substrate. The substrate has first and second faces, first and second transversely extending edges and first and second longitudinally extending sides. Next, the first face of the substrate is printed with high resolution graphics, with the imaging preferably having a resolution of greater than about 150 lines per inch.

Then, a core material is supplied that has a series of regularly occurring undulating portions. The core of material is affixed to the second face of the substrate such that the core is disposed substantially between the first and second transversely extending edges and first and second longitudinally extending sides.

Continuing with a description of the presently described invention, a base sheet is supplied and has first and second faces, first and second transversely extending edges and first and second longitudinally extending sides. The base sheet is affixed or adhered to the core opposite the substrate such that the core is disposed between the base sheet and the substrate to create a printed intermediate assembly. A carton blank is formed from the intermediate assembly, and can be used to create a consumer goods package.

In a yet still further exemplary embodiment of the presently described invention, a consumer goods package is described and includes, a consumer good, such as may be obtained over a global communications network.

A blank of material, the blank has a first surface that is produced from a first substrate that has first and second sides with the first side having high resolution imaging. The blank further includes a fluted material that serves as a core for the blank and a second substrate that has first and second sides with the second side having imaging provided thereon.

The second side of the first substrate is bonded to one side of the core and the second substrate first side is bonded to another side of the core opposite the first substrate. The blank of material is used to form a consumer goods package to hold the consumer good. The imaging provided on the first substrate contains matching features to the imaging provided on the second substrate each of which are related to the consumer good.

In connection any or all of the foregoing exemplary embodiments, the imaging that is produced on the first substrate or printable layer can be performed at a first resolution and the imaging provided on the second or base layer can be achieved at a second resolution level that is distinct from the first resolution level. For example, the printing on the substrate that will become the outer layer of the laminate assembly may have a resolution of greater than about 150 lines per inch and preferably greater than 200 lines per inch, while the imaging on the base layer may have imaging at less than about 150 lines per inch.

In order to form the blank the first substrate, the fluted core and the base sheet are brought into contact with one another and the intermediate assembly is formed substantially in situ, that is substantially at the location of the printing of the substrate and base sheet.

The printing or imaging that is applied to the substrate and base sheet will preferably have matching features or characteristics that are complimentary to the consumer good contained within the package. In addition, the imaging or printing can be used to convey information about other related or complimentary products, upgrades or enhancements for the productions, marketing, advertising or promotional information relating to the products, or other members of the product families as well as product announcements, information and the like.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a schematic showing the in situ formation of a packaging laminated as provided in the present invention;

FIG. 2 illustrates a printed laminate that may be prepared in connection with practicing the present invention;

FIG. 3 shows a carton produced from the laminate prepared in connection with the present invention and which includes a cut away portion showing printing on the interior or base sheet portion of the laminate;

FIG. 4 provides a view of the interior of a consumer goods package prepared in accordance with the present invention and depicting a consumer good contained within the package and related imaging; and

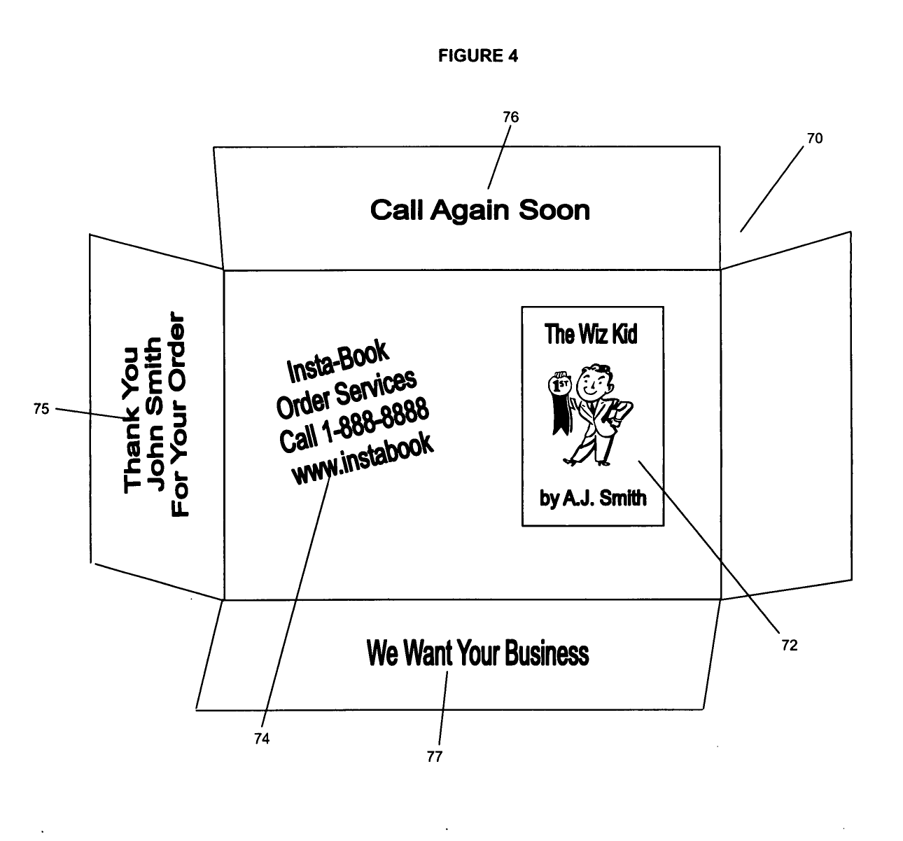

FIG. 5 illustrates a block diagram of an exemplary method that is used in practicing the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The instant specification sets forth a unique concept by which conventional corrugated type packaging material can be prepared using commercial quality imaging and business forms type processing equipment in a manner so as to enhance consumer goods packaging in order to provide a more attractive marketing package for the customer of a particular product or service.

The printing or imaging that is applied to the sheets of material that form the inner and outer surface of a carton when formed will preferably have complimentary imaging to the consumer good that is contained within the package. The imaging or printing can be used to convey information about other related or complimentary products, upgrades or enhancements for the productions, marketing, advertising or promotional information relating to the products, or other members of the product families as well as product announcements, information and the like. In addition, the printing or imaging can be used to create gift packages such as by printing colorful patterns or designs, similar to those found on wrapping paper as well as names and gift giving occasions such as birthdays and holidays. Thus, the invention described in the instant specification can be used to create a personalized package out of relatively bland packaging material.

There are a number of terms used throughout the instant specification which are discussed below in cursory terms. The definitions provided are not intended to limit the scope of the invention and the information is provided for illustrative purposes.

As used herein the term “business communication” is used to refer to a printed or imaged piece, document or substrate that when used with the a laminate as described in the present invention will convey a particular message, image or provide information about a particular product or service that is available from the provider of such pieces or documents. Business communications, documents or pieces can include advertising, sales and marketing collateral and such other items used to convey information, and in connection with the present invention.

The term “intermediate” as used herein refers to a product that undergoes one or more processing steps prior to the intermediate reaching a final condition, that of being ready for end use or application. The additional processing steps may include printing, imaging, folding, forming, sealing, separating, cutting, perforating, scoring, adhering, laminating and the like. Typically, a product such as with the present invention is provided in an intermediate condition so that a user or downstream manufacturing point can add or manipulate the intermediate to create the final or desired end product, such as creating a finished carton or package. Thus, in accordance with the present invention, the intermediate segment for example, could be subject to die cutting or additional printing, such as through ink jetting, over laminating, coating or embossment, and then applied to a blank for further processing, such as to create a package, carton or the like.

The term “personalized information” refers to information that is printed or imaged onto a substrate or document which is generally variable or unique and which may change from laminate to laminate so as to create a customized message or communication for each recipient. Examples of personalized information may include names, addresses, descriptions, plans, coding, numbering, promotional text, recipes based on contents, etc. that may have been acquired from the intended recipient through surveys, questionnaires or answers given to various inquiries generated in response to a request for goods or services.

The term “static or fixed” information refers to printed or imaged information that generally does not change from laminate to laminate and may include a general description or body of information about particular products, services, places, etc. that may be of interest to the intended recipient and represents a standard message that the manufacturing or supplier wishes to convey to an end user or customer of the offering.

Examples of image generating or high quality printing devices that are suitable for use in practicing the invention include high resolution imaging devices such as Indigo®, available from Hewlett Packard of Palo Alto, Calif. or Karat available from KBA of Williston, Vt. Ideally, the present invention seeks to provide images on a substrate that has a resolution quality of about 150 or more lines per inch and preferably more than 300 lines per inch, which is approximately equal to about 2500 to 3500 dots per inch (“DPI”) in order to create a high quality image that is intended to be aesthetically appealing to the consumer. Other imaging equipment may of course be used depending on the sheet or web size that the equipment can efficiently handle.

The system can be used to produce highly personalized textual information in addition to generating high quality, high resolution graphical images. Such textual information may include details relating to the graphics to be generated.

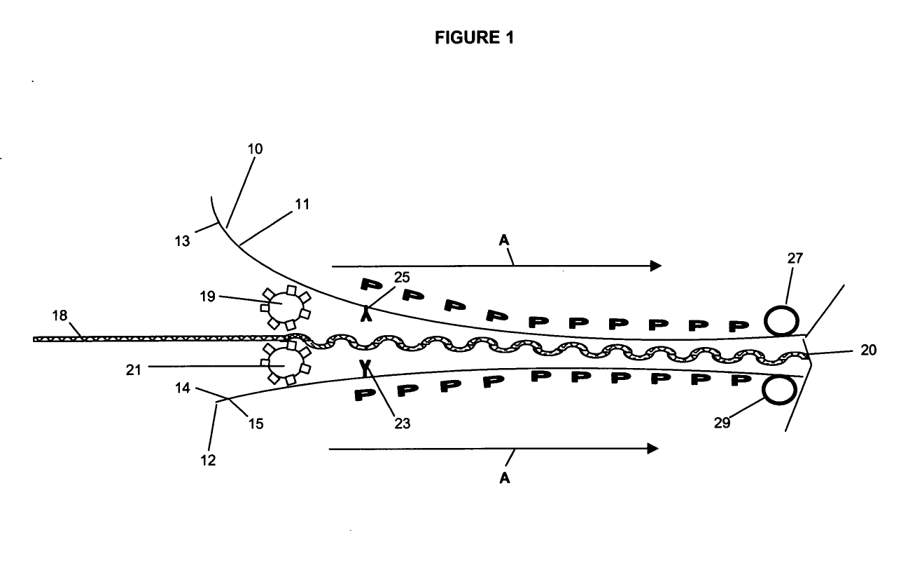

Reference is now directed to FIG. 1 of the presently described invention, in which a schematic is shown illustrating the formation of the printed laminate that may be used in forming packaging. A first substrate 10 is provided and advanced in a machine direction which is represented by the arrow “A”. The substrate is a printable material such as a cellulosic based material that can be readily processed through a high quality imaging device. The first substrate 10 is provided with printing on a first face 11 that is represented by the characters “PPP”. The substrate 10 second face 13 will ultimately be brought into contact with a material that forms the core.

A base sheet 12 is provided that has first and second faces or surfaces 14 and 15 respectively. The second face 15 of the base sheet 12 is provided with printing which is again represented by the characters “PPP”. The first face 14 will be adhered to the core of material as will be described herein. The base sheet 12 will preferably be selected from a similar cellulosic material as that used for the first substrate 10, but it should be understood that the material may be a heavier or lighter stock or may have coatings such as water proof coatings and the like. The base sheet 12 is advanced in a machine direction represented by an arrow designated “A”.

A sheet of material 18 which will become the fluted core 20 is advanced in a machine direction. The sheet of material 18 will again be preferably selected from the same or similar type of material as the top sheet 10 and base sheet 12, however, it should be understood that the sheet may be selected from a different type of material. The material 18 is passed through one or more fluting rollers 19 and 21 which will create an relatively uniform undulating pattern that will serve as the core material 20. Adhesive application stations 23 and 25 are provided to coat the second face 13 of the first substrate 10 and the first face 14 of the base sheet 12 with pressure sensitive adhesive so as to secure each of the substrate 10 and base sheet 12 to the fluted core 20. Laminating rollers 27 and 29 are provided downstream from the adhesive application stations 23 and 25. The laminating rollers 27 and 29 apply a slight but sufficient pressure to bond the substrate, base sheet and core together.

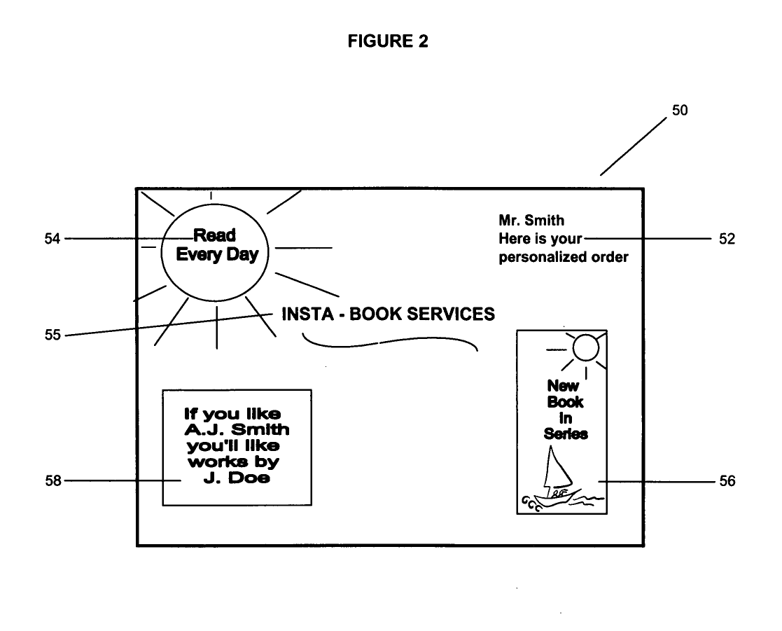

Reference is now directed to FIG. 2 of the presently described invention which shows the external face of the laminated assembly produced from the schematic illustrated in FIG. 1. The printed laminated assembly is generally designated by reference numeral 50. The first substrate 10 shown in FIG. 1 will provide the outside surface of the laminate 50 which is then used to form a carton and will make up the exterior of the carton.

As shown in FIG. 2, the laminate 50 is provided with a number of graphics and textual information. The present invention can be used to create personalized information such as printed at 52 as well as static or fixed textual and graphical information 54 and 55 which may be present on all the cartons used for a particular retailer or product supplier.

The outer surface of the laminate 50 is also printed with personalized information relating to the particular order. For example 56 shows that the order is a new book in a continuing series of literary works and printing at 58 is a tailored marketing message for the customer suggesting a further literary work that may be of interest to the consumer based on the selection made in the current order summary. In this way, individual packages can be created that are directly targeted at each customer as opposed to having a more generic offering. It should however be understood that any level of variability is possible and the surface of the laminate may contain more or less personalized information depending on the demands of the user of the invention.

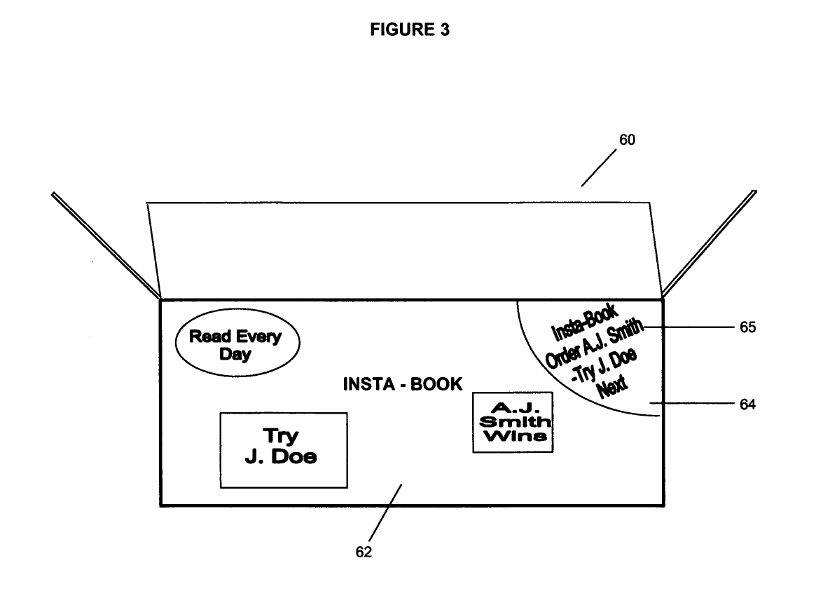

FIG. 3 provides a further illustration of the laminate that is used in connection with the present invention and shows a cut away of the exterior of a carton, generally designated by reference numeral 60. FIG. 3 provides a depiction of the exterior 62 of the carton 60 which will for example show the imaging that has been provided in FIG. 2. The cut away portion 64 shows the interior of the carton, which shows the base sheet 12 from FIG. 1, second side 15 which is printed with related information 65 to that printed on the exterior 62 of the carton 60. In this way, the retailer can provide additional marketing, advertising and informational messages and business communications to the customer thereby taking advantage of the additional available space of the carton 60. The printed information 65 contains matching indicia to that printed on the exterior 62 to tie the entire printed message together to create a more complete communication.

FIG. 3 is provided to illustrate an exemplary use of the present invention as a consumer goods package. In this embodiment, a carton, generally designated by reference numeral 70 includes a consumer good 72, here a literary work such as a book, as well as shows imaging on the interior of the carton. The imaging again may be static printed information 74, showing contact information as well as personalized information at 75 relating to the specific customer or type of order that has been placed. Additional static information may be printed at 76 and 77 to communicate additional marketing or advertising messages to the recipient.

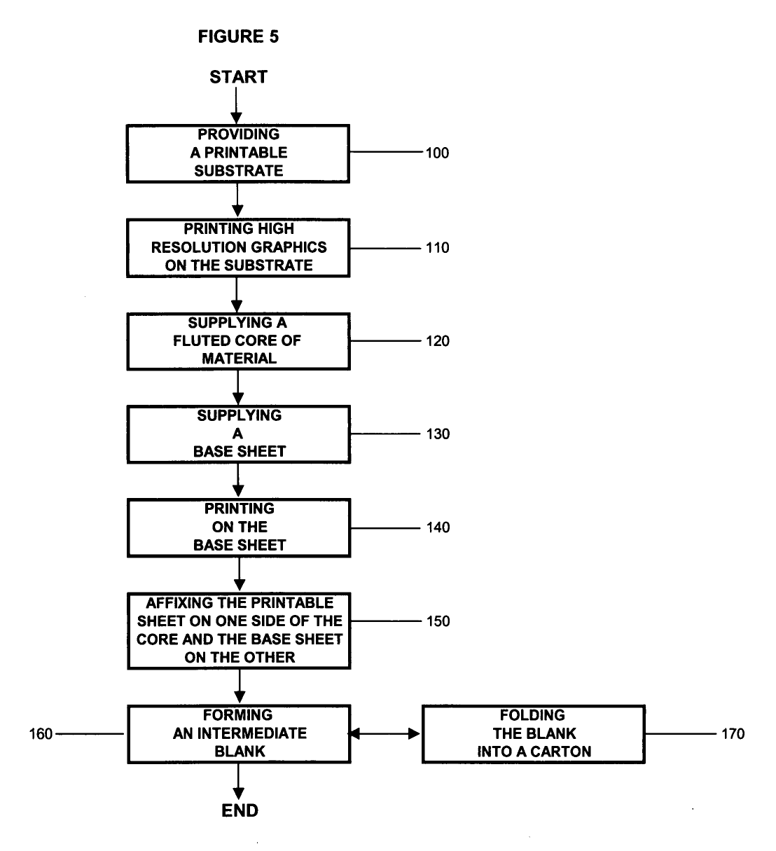

FIG. 5 shows a block diagram of the present invention showing an exemplary method for carrying out construction or assembly of the laminate. The process is started by providing a first printable substrate at step 100. As previously indicated, the substrate will preferably be a cellulosic stock of material. Next, printing at a relatively high resolution is provided at step 110. The printing is preferably provided at a resolution level of at least about 150 lines per inch, and preferably greater than about 200 lines per inch. Printing may be accomplished in either a cut sheet configuration or in a continuous or roll fed type of system.

A material is provided at step 120 which will make up the fluted core of the laminate that is formed. Next, a base sheet is supplied at step 130. The base sheet will preferably be selected from a similar stock of material as the substrate as well as the material that will become the fluted core. By proceeding in this fashion, the manufacturer can then take advantage of volume discounts by ordering larger quantities of the same types of material as opposed to smaller quantities of different materials. In addition, the manufacturer does not have to be concerned about running short of one type of material.

The base sheet is printed at step 140. As with the printing of the substrate at step 110, the printing may include text, graphics or both and may be repeating types of printing, that is static or fixed printing or alternatively, may be variable or personalized printing or imaging.

The base sheet and substrate are then attached to the core at step 150. This is preferably accomplished by applying a pattern of pressure sensitive adhesive to the second face of the substrate or first sheet and first face of the base sheet that will form the interior of the carton or package. The sheets may then be pressed into contact with the core by using a light laminating pressure, such as by passing the laminate through a pair of laminating rollers.

An intermediate blank is then formed at step 160. If the laminate is prepared from a series of cut sheets, the formation of the blank may include trimming and cutting slits in the laminate, adding score lines such as to facilitate folding and the like. If the laminate is formed from a continuous assembly, in addition to the actions described above, individual blanks are severed from the roll in order to make up the separate blanks of the material. The blank may then be folded at step 170 in order to form the carton or package for the consumer good.

It will thus be seen according to the present invention a highly advantageous printed intermediate having a fluted core that may be used in conventional corrugated packaging applications has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A method for producing a printed intermediate assembly for use in consumer goods packaging, comprising the steps of;
providing a printable substrate, said substrate having first and second faces, first and second transversely extending edges and first and second longitudinally extending sides;
printing said first face with high resolution graphics;
supplying a core, said core having a series of regularly occurring undulating portions and having first and second sides;
affixing said first side of said core to said second face of said substrate such that said core is disposed substantially between said first and second transversely extending edges and first and second longitudinally extending sides; and
adhering a base sheet to said second side of said core, said base sheet having first and second faces, first and second transversely extending edges and first and second longitudinally extending sides, said base sheet is secured to said core opposite said substrate such that said core is disposed between said base sheet and said core to create a printed intermediate assembly having a fluted core.

2. A method as recited in claim 1, wherein said graphics are produced at a resolution of greater than about 150 lines per inch.

3. A method as recited in claim 1, wherein said graphics are produced at a resolution of greater than about 200 lines per inch.

4. A method as recited in claim 1, including a further step of printing on one of said first and second faces of said base sheet with high resolution graphics prior to the step of adhering.

5. A method as recited in claim 4, wherein said graphics printed on said base sheet are produced at a resolution of greater than about 150 lines per inch.

6. A method as recited in claim 1, including a further step of folding said printed intermediate to create a package after the step of adhering.

7. A method as recited in claim 1, wherein said printing includes personalized or variable printed information.

8. A method as recited in claim 1, including a further step of creating fluting in said core substantially simultaneously prior to the step of supplying said core.

9. A method as recited in claim 1, including a further step of forming a carton blank by die cutting said intermediate assembly after the step of adhering the base sheet to the core.

10. A method as recited in claim 9, including a further step of folding said carton blank to form a carton after the step of forming said carton blank.

11. A printed intermediate blank for use in consumer goods packaging produced in accordance with the following process including the steps of;
providing a printable substrate, said substrate having first and second faces, first and second transversely extending edges and first and second longitudinally extending sides;
printing said first face of said substrate with high resolution graphics;
supplying a core, said core having a series of regularly occurring undulating portions;
affixing said core to said second face of said substrate such that said core is disposed substantially between said first and second transversely extending edges and first and second longitudinally extending sides;
adhering a base sheet, said base sheet having first and second faces, first and second transversely extending edges and first and second longitudinally extending sides to said core opposite said substrate such that said core is disposed between said base sheet and said substrate to create a printed intermediate assembly; and
forming a carton blank from said intermediate assembly.

12. A printed intermediate blank as recited in claim 11, including a further step of folding said carton blank to form a package after the step of forming a carton blank.

13. A printed intermediate blank as recited in claim 12, including a further step of packaging a consumer good in said package after the step of folding said carton blank.

14. A printed intermediate blank as recited in claim 11, wherein said substrate is printed at a first resolution and said base sheet is printed at a second resolution distinct from said from said first resolution.

15. A printed intermediate blank as recited in claim 11, wherein said intermediate blank is formed substantially in situ.

16. A consumer goods package, comprising;
a consumer good;
a blank of material, said blank having a first surface that is produced from a first substrate having first and second sides with said first side having high resolution imaging, said blank further including a fluted material that serves as a core for said blank and a second substrate that has first and second sides with said second side having imaging provided thereon;
said second side of said first substrate is bonded to one side of said core and said second substrate first side is bonded to another side of said core opposite said first substrate;
said blank of material forming a consumer goods package; and
said imaging provided on said first substrate contains matching features to said imaging provided on said second substrate and each of which are related to said consumer good.

17. A consumer goods package as recited in claim 16, wherein said imaging provided on said first substrate is produced at a resolution distinct from said imaging provided on said second substrate.

18. A consumer goods package as recited in claim 16, wherein said imaging provided on said first substrate is produced at a resolution of greater than about 150 lines per inch.

19. A consumer goods package as recited in claim 16, wherein said matching features of said imaging are selected from a group including product announcements, upgrade information, new releases, complimentary product information, colorful patterns and designs and combinations thereof.

20. A consumer goods package as recited in claim 16, wherein said consumer goods package is substantially formed in situ.
